(19) United States
(12) Patent Application Publication
(10) Pub. No.: US 2024/0430860 A1
(43) Pub. Date: Dec. 26, 2024

(54) METHOD PERFORMED BY USER EQUIPMENT, AND USER EQUIPMENT

(71) Applicant: SHARP KABUSHIKI KAISHA, Sakai City, Osaka (JP)

(72) Inventors: Xiaojun MA, Shanghai (CN); CHAO LUO, Shanghai (CN); RENMAO LIU, Shanghai (CN)

(21) Appl. No.: 18/696,250

(22) PCT Filed: Sep. 29, 2022
(86) PCT No.: PCT/CN2022/122522

§ 371 Date: Mar. 27, 2024

(30) Foreign Application Priority Data
Sep. 29, 2021 (CN) 202111156505.3

(51) Int. Cl. H04W 68/02; H04W 76/27

(52) U.S. Cl. CPC H04W 68/02; H04W 76/27

(57) ABSTRACT

Provided in the present invention is a method performed by user equipment (UE), including: acquiring the position of a paging early indication (PEI) occasion, the position associated with the distance between a specific PEI occasion related to the UE and a specific paging frame (PF) related to the UE; and determining the PEI indication information according to the position of the PEI occasion.

### TECHNICAL FIELD

The present invention relates to the technical field of wireless communications, and in particular to a method performed by a user equipment, and an associated user equipment.

### BACKGROUND

User experience is one of the key factors of the success of 5G/NR, and is not merely a user-experienced data rate and delay, and reduction in terminal power consumption is also an important aspect. The enhanced technical solution of reduction in terminal power consumption is one of the elements of the success of 5G/NR. Although some existing techniques have been used for the reduction in terminal power consumption, an additional enhanced evolved technology is still one of the key technologies in future development. For example, the power consumption reduction technology may be applied to a terminal in an idle state or an inactive state, thereby facilitating further reduction in power consumption of a terminal device in an associated state while ensuring a communication capability, or improving a signal receiving capability, and achieving some other benefits.

### SUMMARY

In order to solve at least some of the above problems, provided in the present invention are a method performed by user equipment, and user equipment. PEI indication information reception can enable a terminal to be capable of further acquiring an accurate measurement or parameter estimate, more sleep time, a better signal receiving capability, or the like, so that the terminal achieves benefits such as reduction in power consumption and improvement in the receiving capability, thereby improving a network service capability and expanding network compatibility, such that costs of communication network deployment are greatly reduced.

In order to solve at least some of the above problems, according to an aspect of the present invention, provided is a PEI indication information determination method performed by user equipment (UE), comprising: acquiring the position of a paging early indication (PEI) occasion, the position associated with the distance between a specific PEI occasion related to the UE and a specific paging frame (PF) related to the UE; and determining the PEI indication information according to the position of the PEI occasion.

In addition, according to, according to the present invention, provided is a PEI indication information determination method performed by user equipment (UE), comprising: acquiring a capacity value of a paging early indication occasion, i.e., a PEI occasion, the capacity value being the number of paging occasions associated with one PEI occasion; and determining the specific PEI indication information according to the capacity value.

In addition, according to the present invention, provided is user equipment, comprising: a processor; and a memory, having instructions stored therein, wherein when run by the processor, the instructions perform the aforementioned method.

### BRIEF DESCRIPTION OF THE DRAWINGS

The above and other features of the present invention will be more apparent from the following detailed description in combination with the accompanying drawings, in which:

FIG. 1 is a schematic diagram of user equipment determining a PF, a PO, and an MO in a paging cycle.

FIG. 2 is a flowchart showing a method performed by user equipment according to an embodiment of the present invention.

FIG. 3 is an example showing that a terminal determines a PEI information mapping means according to a higher layer indication.

FIG. 4 is an example showing that a terminal determines a PEI information mapping means according to a physical layer indication.

FIG. 5 is a flowchart showing a method performed by user equipment according to an embodiment of the present invention.

FIG. 6 is an example showing that a user determines the position of PEI information in DCI according to an embodiment of the present invention.

FIG. 7 is an example showing that a user determines an index of PEI information in DCI according to an embodiment of the present invention.

FIG. 8 is a flowchart of a method performed by a user to determine an index of PEI information in DCI according to an embodiment of the present invention.

FIG. 9 is a block diagram schematically showing user equipment according to the present invention.

### DETAILED DESCRIPTION

The following describes the present invention in detail with reference to the accompanying drawings and specific embodiments. It should be noted that the present invention should not be limited to the specific embodiments described below. These embodiments are merely provided as examples to convey the scope of the subject matter to those skilled in the art. In addition, detailed descriptions of well-known technologies not directly related to the present invention are omitted for the sake of brevity, in order to avoid obscuring the understanding of the present invention.

Typically, all terms used herein will be interpreted according to the ordinary meaning thereof in the related technical field unless different meanings are clearly presented and/or implied in the context where the terms are used. Unless specified otherwise clearly, all references to a/one/the element, apparatus, assembly, component, step, etc., should be publicly interpreted as referring to at least one instance of the element, apparatus, assembly, component, step, etc. The steps of any method disclosed herein do not need to be performed in the exact order disclosed unless one step has to be explicitly described as being after or before another step and/or one step has to be after or before another step as implied. In appropriate cases, any feature of any embodiment disclosed herein is applicable to any other embodiment. Likewise, any advantage of any embodiment is applicable to any other embodiment, and vice versa.

In the following description, a 5G/NR mobile communication system and later evolved versions thereof are used as exemplary application environments to describe a plurality of embodiments according to the present invention in detail. However, it is to be noted that the present invention is not limited to the following embodiments, but is applicable to many other wireless communication systems, such as a communication system after 5G, a 4G mobile communication system before 5G, and an 802.11 wireless network.

Some terms involved in the present invention are described below. Unless otherwise specified, the terms used in the present invention use the definitions herein. The terms given in the present invention may vary in LTE, LTE-Advanced, LTE-Advanced Pro, NR, and subsequent or other communication systems, but unified terms are used in the present invention. When applied to a specific system, the terms may be replaced with terms used in the associated system.

3GPP: 3rd Generation Partnership Project

LTE: Long Term Evolution

NR: New Radio

UE: User Equipment

gNB: NR base station

FR1: Frequency range 1 as defined in TS 38.104

FR2: Frequency range 2 as defined in TS 38.104

BWP: Bandwidth Part

SFN: System Frame Number

OFDM: Orthogonal Frequency Division Multiplexing

CP: Cyclic Prefix

TA: Timing Advance

SCS: Sub-Carrier Spacing

RB: Resource Block

RE: Resource Element

CRB: Common Resource Block

PRB: Physical Resource Block

VRB: Virtual Resource Block

REG: Resource Element Group

EPRE: Energy Per Resource Element

TDD: Time Division Duplexing

FDD: Frequency Division Duplexing

CSI: Channel State Information

DCI: Downlink Control Information

MCS: Modulation and Coding Scheme

SRS: Sounding Reference Signal

DMRS: Demodulation Reference Signal

CSI-RS: Channel State Information Reference signal

TRS: Tracking Reference Signal

CRC: Cyclic Redundancy Check

SFI: Slot Format Indication

QCL: Quasi Co-Location

HARQ: Hybrid Automatic Repeat Request

SIB: System Information Block

SIB1: System Information Block Type 1

PSS: Primary Synchronization Signal

SSS: Secondary Synchronization Signal

MIB: Master Information Block

SSB: Synchronization Signal Block

CORESET: Control Resource Set

RACH: random-access channel

PBCH: Physical Broadcast Channel

PUCCH: Physical Uplink Control Channel

PUSCH: Physical Uplink Shared Channel

PRACH: Physical random-access channel

PDSCH: Physical downlink shared channel

PDCCH: Physical downlink control channel

UL-SCH: Uplink Shared Channel

DL-SCH: Downlink Shared Channel

NZP-CSI-RS: Non-Zero-Power CSI-RS

C-RNTI: Cell Radio Network Temporary Identifier

P-RNTI: Paging RNTI

RA-RNTI: Random Access RNTI

CS-RNTI: Configured Scheduling RNTI

SI-RNTI: System Information RNTI

TC-RNTI: Temporary C-RNTI

TMSI: Temporary Mobile Subscriber Identity

The following is a description of technologies associated with the solution of the present invention. Unless otherwise specified, the same terms in the specific embodiments have the same meanings as in the associated technologies.

It is worth pointing out that the user, the user equipment, and the terminal device in the specification of the present invention have the same meaning, and UE may also be used herein to represent user equipment, which will not be specifically differentiated or defined hereinafter. Similarly, network devices are devices communicating with a terminal, and include, but are not limited to, a base station device, a gNB, an eNB, a wireless AP, a wireless relay, a terminal having a relay capability, etc., and will not be specifically differentiated or defined hereinafter. Herein, description may be provided by using a base station as a form of a network device that is implemented, and in a specific implementation, other network device forms may be easily used for replacement.

In the network, a slot is used as a unit to define an associated resource. According to different network settings, one slot may include 14 (in a normal CP scenario) or 12 (in an extended CP scenario) OFDM symbols. One or more slots may form a subframe and a radio frame. Typically, in the network, one radio frame has a length of 10 milliseconds. According to different subcarrier spacing parameters, one radio frame may consist of several slots. For example, when the subcarrier spacing is 15 kHz, one radio frame consists of 10 slots, and when the subcarrier spacing is 30 kHz, one radio frame consists of 20 slots, and so on. The terminal may determine the slot location according to parameters such as a frame number SFN of the radio frame and the sequence number of the slot in the radio frame. The terminal may also determine a symbol location of signal transmission in the time domain according to the sequence number of a symbol in the slot.

Resources in the network may also be defined via resource blocks (RBs) and resource elements (REs). The resource block (RB) may be defined as N_{sc}^{RB}=12 consecutive subcarriers in the frequency domain. For example, for the subcarrier spacing parameter of 15 kHz, one RB is 180 kHz in the frequency domain. A resource element (RE) is a resource determined by one OFDM symbol and one subcarrier. That is, one RE is one subcarrier in the frequency domain, and is one OFDM symbol in the time domain.

The terminal performs PDCCH signal reception on related resources according to a PDCCH channel parameter configured by the network. A resource of a PDCCH may be determined via CORESET and search space set parameters. The terminal may determine, according to the CORESET and search space set parameters, a time-frequency resource parameter used by the PDCCH. For example, the period, a slot number, the position of a starting symbol in a slot, etc., of a resource used by a PDCCH channel is determined according to the search space set parameter. The number of symbols, a frequency domain resource parameter, etc., used by each CORESET are determined according to the CORESET parameter. Via the search space set and CORESET parameters and necessary BWP parameters, etc., the terminal can determine several resources or resource sets for transmitting a PDCCH signal. These resources or resource sets may be used for the terminal to perform PDCCH signal detection, and therefore may also be referred to as several PDCCH monitoring occasions. DCI signaling transmitted by a PDCCH bearer to the terminal is used to indicate information such as resource configurations or an action or behavior that the terminal needs to perform. The terminal monitors a PDCCH on a PDCCH monitoring occasion, and performs descrambling and CRC checking according to an RNTI configuration parameter, etc., so as to determine whether there is DCI transmitted to the terminal. If DCI can be correctly demodulated, the terminal may perform a further action according to an indication of the DCI.

According to different cases such as whether a connection to a wireless network is established and whether a wireless connection is suspended, terminals in the network may be divided into different states, such as a connected state, an idle state, an inactive state, and the like. A wireless connection is established between a user in the connected state and the network, and is used to perform data transmission or relevant service processing. A terminal in the idle state or the inactive state also maintains a certain connection to the network. For example, the terminal needs to monitor, according to a relevant configuration or parameter, a broadcast message and a paging message transmitted by the network, or perform relevant measurement, or the like. The processing of the user in the idle state is similar to the processing of the user in the inactive state in many aspects of the present invention. In order to avoid redundancy, if not indicated otherwise, in the present invention, the relevant actions related to the terminal in the idle state or the network may also be applied to the terminal in the inactive state. Other user states similar to the idle state may also be processed by analogy, and details will not be described herein.

If the terminal in the idle or inactive state does need to receive, transmit, measure, or the like, any signal, the terminal may be in a sleep state to reduce power consumption. According to different requirements, the terminal may be in different sleep modes. For example, the terminal enters a light sleep mode for transient dormancy in which a new signal needs to be processed within a short time. As another example, the terminal enters a deep sleep mode used when the terminal does not need to process any new signal within a long time, and the deep sleep mode may reduce more power consumption of the terminal than the light sleep mode. Generally, in the case that no service function is affected, causing the terminal to be in the dormant mode can effectively reduce power consumption of the terminal, thereby improving the user experience.

The terminal in the idle state or the inactive state needs to periodically receive information of the network, such as paging information, a SIB updating message, etc. The terminal in the idle state or the inactive state may use a discontinuous reception (DRX) mode to receive a message of the network so as to reduce power consumption. That is, in one DRX period, the terminal is woken up and performs reception in only part of the time. For example, the terminal determines the position of a paging occasion in each paging cycle according to a parameter configured by the network, monitors a paging PDCCH on a paging PDCCH monitoring occasion related to the paging occasion, and performs a further action according to content indicated in the paging PDCCH. For example, the terminal can determine, according to network configurations, a DRX cycle parameter T and a paging frame (PF) parameter N in a DRX cycle for receiving a paging message. One paging frame is one radio frame, and may include one or more paging occasions (POs) or the start of one PO. Simply put herein, one PF is associated with one or more POs, or one PF includes one or more POs. Similarly, the PF may also be referred to as a PF of these POs. One paging occasion consists of several paging PDCCH monitoring occasions (MOs). When a plurality of beams are used to perform transmission in the network, different MOs may correspond to different beams, so that terminals in different positions can all obtain good downlink reception. For example, N paging frames are present in one paging DRX cycle having the period being T radio frames, and the terminal determines, according to a rule and a parameter, that one of the N paging frames is a paging frame in which the terminal needs to monitor a paging PDCCH. When one paging frame corresponds to a plurality of POs, the terminal determines, according to a rule and a parameter, that one of the plurality of POs is a PO monitored by the terminal. The terminal may then select, according to a circumstance that the terminal is in, an MO in the PO to receive a PDCCH. For example, one or more certain MOs are selected according to beam information to monitor a paging PDCCH. If the terminal detects a valid paging DCI, the terminal performs paging PDSCH reception or another related action according to detected DCI.

In a specific example, the terminal may acquire, according to an identifier of the terminal such as a TMSI or an IMSI, a parameter UE_ID for determining a paging occasion. A terminal identifier typically uses a large number of bits. For example, a 5G-S-TMSI uses 48 bits. Terminals of different terminal identifiers may be mapped to the same UE_ID via a certain operation, thereby simplifying the design of paging. For example, via the 5G-S-TMSI of the terminal, it is determined that UE_ID=S-TMSI mod 1024, where mod is a modulo operation. Terminals using the same UE_ID use the same PF and PO to monitor a paging PDCCH.

Furthermore, the terminal acquires, according to a parameter configured by the network, a frame number SFN of a PF associated with a PO that the user needs to monitor, and the frame number SFN satisfies the following condition:

(SFN+PF_offset)mod T=(T/N)*(UE_ID mod N)

where PF_offset is a paging frame offset value configured by the network, and T is a paging cycle determined by the terminal. N is the number of paging frames in one paging cycle. mod is the modulo operation.

The terminal determines the frame number of the paging frame (PF), and then determines the related PO. According to different network configurations, one PF may be associated with a plurality of POs. The UE needs to determine to monitor one certain PO among the plurality of POs to monitor a paging PDCCH and determine whether an associated paging message is present, and the like. For example, the terminal may determine, according to an index i_s of the PO related to the PF, the PO that the terminal needs to monitor:

i_s=floor(UE_ID/N)mod Ns

Ns is configured by the network, and is the number of POs associated with one PF. floor is a rounding down operation.

After the terminal determines the index of the PO, the terminal may determine information of each monitoring occasion (MO) according to a paging search space set parameter configured by the network. For example, the terminal may determine, starting from a PF radio frame and according to a search space set configuration and a CORESET configuration of a paging PDCCH, the index of the PO associated with the PF and S*X consecutive MOs of the PO. S is the number of SSBs actually transmitted in one SSB cycle in the network, and may be determined, for example, via a parameter ssb-PositionsInBurst in SIB1. The value of X is 1 by default, and may be configured by a higher layer. Each S MOs are respectively related to S different SSB sequence numbers. That is, S MOs are respectively satisfy a QCL relationship with S SSBs in a one-to-one manner.

For example, as shown in FIG. 1, the terminal may determine two PFs in one paging cycle according to configurations. The terminal determines, according to the TMSI of the UE, etc., that the UE uses a first PF as the PF of the terminal. Similarly, the terminal may determine, according to a related parameter, that the index of the monitored PO is PO1, and determine four MOs associated with PO1. The terminal monitors the paging PDCCH on the related MOs.

According to the above method, the terminal may receive the paging PDCCH on the determined MOs, and receive and demodulate related DCI. The DCI in the paging PDCCH includes some information, for example, for indicating whether a user has an associated paging message that the user needs to receive. If there is a paging message to receive, PDSCH resource parameters for transmitting the paging message are further indicated in the DCI, including parameters such as a time domain resource, a frequency domain resource, a modulation means, etc.

To reduce power consumption, the terminal in the idle state typically operates in a DRX state. When the terminal does not receive data, the terminal enters a dormant state. When the terminal operates, a time-frequency deviation between the terminal and the base station may be present. Particularly when in the dormant state, continuous accumulation of small deviations may become a large deviation. When the terminal receives data, the terminal needs to satisfy a state of time-frequency synchronization with the base station, so as to ensure correct transmission of the data. The terminal may perform time-frequency tracking by receiving an SSB, so as to obtain more accurate synchronization with the base station. Therefore, when performing PO monitoring to receive the PDCCH, the terminal needs to be woken up in advance, and receive a plurality of SSBs, so as to achieve the time-frequency synchronization of the terminal and the network. If DCI detected by the terminal in a PO indicates that there is no paging data to receive, the terminal may re-enter the dormant mode to reduce power consumption.

The network may transmit indication information before a PO monitored by the terminal, to indicate whether the terminal needs to monitor an associated PO in one or more paging cycles. The indication information may be referred to as a paging early indication (PEI), or may have another name. In the following, PEI may be collectively used to refer to related information. For example, when there is paging information in the network that needs to be received by the terminal, the network transmits PEI indication information used to indicate that the terminal needs to monitor a PO associated with the indication information. The terminal is woken up before the PO, performs time-frequency synchronization, and monitors a paging PDCCH and performs possible PDSCH reception on the determined PO. If it is indicated in the indication information received by the terminal that the terminal does not need to monitor the PO associated with the indication information, the terminal does not need to perform monitoring on the associated PO, and does not need be woken up and receive an SSB to perform time-frequency synchronization before the PO to prepare for the possible PDSCH reception. In this way, the terminal can avoid, via the indication of the network, unnecessary actions such as waking up, synchronization, etc., thereby reducing power consumption of the terminal.

The indication information PEI may be transmitted by using a PDCCH channel. The network configures search space set and CORESET parameters used by a PDCCH transmitting PEI information, and the terminal may determine monitoring resources related to the PEI-PDCCH. The terminal may determine, according to a configuration of the PEI, a PEI occasion monitored by the terminal and a PEI-PDCCH monitoring occasion related to the PEI occasion. The terminal acquires related PEI indication information in PEI-DCI detected on the PEI occasion, and the related PEI indication information is used to determine whether a related PO needs to be monitored.

An implementation method of the present invention is described below with reference to specific embodiments.

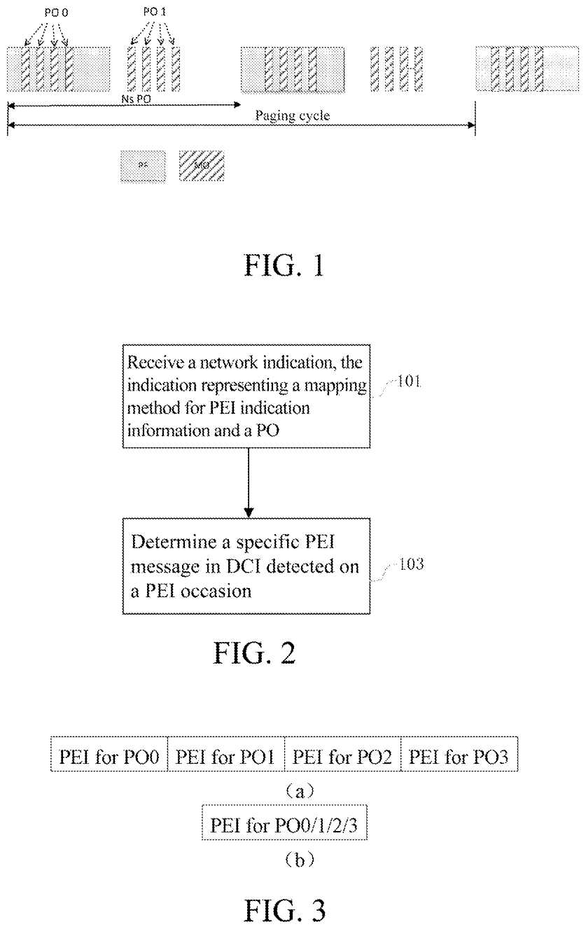

FIG. 2 is a flowchart showing a method performed by user equipment according to an embodiment of the present invention.

As shown in FIG. 2, in step 101, a terminal receives an indication, the indication representing a mapping method for PEI indication information and a PO.

Then, in step 103, the terminal determines, according to the indication, a specific PEI message in DCI detected on a PEI occasion.

To reduce resource overhead in a network or avoid a conflict in PDCCH monitoring or the like, one PEI occasion may be configured to correspond to one or more POs in the network. That is, one PEI occasion is used to indicate PEI information of one or more POs, so as to reduce consumption of PDCCH resources required for PEI transmission. In this case, the terminal monitoring different POs may monitor, on a PDCCH monitoring occasion of one PEI occasion, PEI-DCI carried by a PDCCH. This PEI-DCI may use one field to collectively indicate PEI information associated with these POs. For example, one bit is used to indicate that all related POs need to be monitored or do not need to be monitored in a target DRX cycle. As another example, a means of further dividing several UEs mapped to the same PO into groups may be used to indicate PEI information of each group. For example, n bits are used to indicate paging information situations of n terminal groups on the PO, and each bit corresponds to an indication of one group of UEs, so that n-bit PEI information can be used to indicate that each group of terminals need to monitor or do not monitor related POs among all related POs in the target DRX cycle. The load of DCI in this scenario is small, and good reception performance can be achieved.

Using such a means results in low efficiency in some cases, and cannot achieve a good terminal power saving effect. For example, when a large number of terminals are present in a cell, differences between occasions on which different terminals are paged are large, so that using a common PEI indication may result in terminals being unnecessarily woken up, thereby reducing the power saving effect. In another alternative method, PEI-DCI includes a field transmitted to a number of different terminals or associated with different POs. A terminal monitoring the PEI occasion needs to identify a field related to the terminal, for example, to acquire an index of the related field, so as to acquire PEI indication information needed by the terminal, so that the terminal can determine, according to the respective indication, whether to monitor an associated PO. Furthermore, in each field, a grouping means may be used to indicate that a paging indication situation of each group of terminals on the same PO is monitored, and the terminal may further determine, according to an indication of the group in which the terminal is located, whether the terminal monitors a related PO.

In an optional embodiment, the terminal determines, according to a higher layer or physical layer indication, a mapping means used for indication information of PEI-DCI. That is, a common field is used to indicate PEI information of at least one PO, or independent fields are used to respectively indicate PEI information of different POs. In this way, the network may better utilize resources according to actual network deployment or terminal activity situations, etc. The terminal determines, according to an indication of the network, a method for mapping PEI information to a PO, thereby being capable of correctly receiving PEI indication information, and achieving a good power saving effect.

In a specific example, the terminal determines, according to a higher layer indication, a field associated with PEI information in PEI-DCI monitored on a PEI occasion. When the higher layer indication uses 0, the terminal determines common PEI indication information on the PEI-DCI. That is, all terminals use the PEI index 0 to acquire related PEI indication information. When the higher layer indication uses 1, the terminal determines that an individual PEI indication is used on the PEI-DCI. The terminals need to acquire a related index according to a certain method, thereby acquiring respective PEI indication information.

For example, as shown in FIG. 3, one PEI occasion corresponds to four POs. That is, one instance of PEI-DCI includes PEI indication information for four POs. When the higher layer indication uses a common PEI indication, as shown in FIG. 3(b), the terminal determines that the sole PEI indication or the first PEI indication in the PEI-DCI is used as the PEI indication thereof to determine a monitoring situation of a related PO. When the higher layer indication uses an individual PEI indication, as shown in FIG. 3(a), the terminal needs to determine a PEI index associated therewith and acquire associated PEI indication information.

Optionally, the terminal determines a PEI information mapping means according to a higher layer indication, and determines the size of the PEI-DCI. The terminal performs blind monitoring of a PDCCH and PEI-DCI monitoring according to the determined size of the PEI-DCI. In a specific example, the PEI-DCI may include a field for indicating common information and a field for indicating one or more instances of PEI information. When the higher layer indication uses a common PEI indication, the terminal determines the size of the PEI-DCI, and determines the size of the entire PEI-DCI according to the number of bits required by a set of PEI information. For example, when n bits are used to indicate PEI information, the terminal determines that the size of the PEI-DCI is n bits plus other common bits. When the higher layer indication uses an individual PEI indication, the terminal determines the size of the PEI-DCI, and determines the size of the entire PEI-DCI according to the number D of POs associated with a PEI occasion and the number of bits required by PEI information. For example, when n bits are used to indicate one instance of PEI information, the terminal determines that the size of the PEI-DCI is n*D bits plus other common bits.

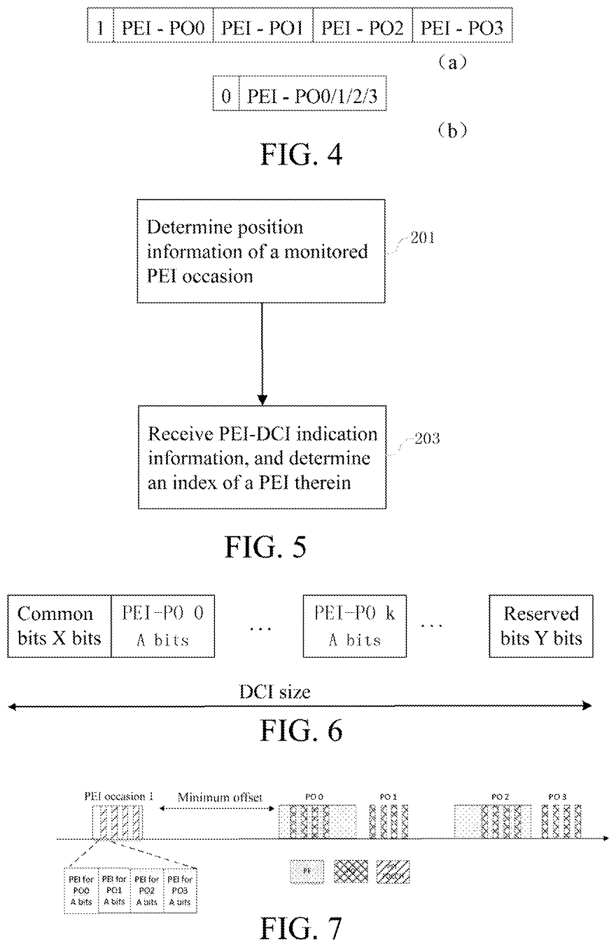

In a specific example, the terminal determines, according to an indication of physical layer signaling, a field associated with PEI information in PEI-DCI monitored on a PEI occasion. For example, when a physical layer indication parameter uses 0, the terminal determines common PEI indication information on the PEI-DCI. That is, all terminals use the PEI index 0 to acquire related PEI indication information. When the physical layer indication parameter uses 1, the terminal determines that an individual PEI indication is used on the PEI-DCI. The terminals need to acquire a related index according to a certain method, thereby acquiring respective PEI indication information. For example, as shown in FIG. 4, one PEI occasion corresponds to four POs. That is, one instance of PEI-DCI includes PEI indication information for four POs. When the bit 0 is used in DCI to indicate that a common PEI indication is used, as shown in FIG. 4(b), the terminal determines that the sole PEI indication or the first PEI indication in the PEI-DCI is used as the PEI indication thereof to determine a monitoring situation of a related PO. When the bit 1 is used in DCI to indicate that an independent PEI indication is used, as shown in FIG. 4(a), the terminal needs to determine a PEI index associated therewith and acquire associated PEI indication information.

Optionally, when the physical layer is used to indicate a mapping means of the PEI-DCI, the terminal always determines the size of the PEI-DCI according to a larger DCI size. The PEI-DCI may include a field for indicating common information and a field for indicating one or more instances of PEI information. When the PEI-DCI uses a different mapping means, the actual length of the PEI information field may be different. For example, when a common PEI indication is used, the actual length of the PEI information field is the length of one instance of PEI information, and when an independent PEI indication is used, the actual length of the PEI information field is the length of D instances of PEI information. The terminal always determines the size of the PEI-DCI according to a larger DCI size, to avoid difficulties in PDCCH monitoring. The terminal performs blind monitoring of a PDCCH and PEI-DCI monitoring according to the determined size of the PEI-DCI.

FIG. 5 shows a flowchart of a method performed by user equipment according to another embodiment of the present invention.

As shown in FIG. 5, in step 201, a terminal acquires position information of a PEI occasion that needs to be monitored.

Then, in step 203, the terminal determines, according to the position information, an index of a PEI message in DCI detected on the PEI occasion.

To reduce resource overhead in the network or avoid a conflict in PDCCH monitoring or the like, one PEI occasion may be configured to correspond to one or more POs in the network. That is, one PEI occasion is used to indicate PEI information of one or more POs, so as to reduce consumption of PDCCH resources required for PEI transmission. In this case, PEI-DCI transmitted by a PEI occasion may include a field transmitted to a number of different terminals or associated with different POs. A terminal monitoring the PEI occasion needs to identify a PEI information field associated with a PO monitored thereby in the DCI, for example, to acquire an index of the related field, thereby acquiring PEI indication information required by the terminal, and determining, according to the indication, whether to monitor an associated PO. In addition, in each PEI information field, a grouping means may be used to indicate a paging indication situation of different terminals monitoring the same PO, and the terminal may determine, according to an indication of each group, whether the terminal monitors a related PO. For example, as shown in FIG. 6, in the PEI-DCI, a field having a length of A bits is used to indicate PEI indication information associated with a PO. The terminal determines that the index of the PO related thereto in the PEI-DCI is k, so that the terminal can determine that A bits starting from the ((k−1)*A)-th bit in a PEI information portion of the PEI-DCI are PEI indication information associated with the PO of the terminal, and therefore can determine, according to the indication information, whether the related PO is monitored.

In an optional embodiment, the terminal determines PEI information according to position information of a PEI occasion, and the position information is the distance between a PEI occasion and a PF of a PO monitored by a user.

The terminal may determine the correspondence between the PEI monitoring occasion and the PO according to the distance between the PEI monitoring occasion and the PF of the PO monitored by the user, and the terminal determines an index of PEI information associated with the PO in PEI-DCI of the PEI monitoring occasion according to the distance, a paging parameter, etc. The terminal may determine, according to the index, PEI information associated with the PO.

In an optional example, the network configures a minimum offset K between a PEI occasion and a PF radio frame of a PO. The terminal determines that the distance to a PF frame related to a PO monitored by the terminal is greater than or equal to the value of K, and a first PEI occasion located before the PO is a PEI occasion associated with the PO. The terminal may monitor a PDCCH resource on the PEI occasion to obtain related DCI. The terminal acquires an index of related PEI information according to a distance and a paging parameter, thereby acquiring PEI indication information of a PO monitored by the terminal.

In a specific example, as shown in FIG. 7, a terminal monitoring PO0/1/2/3 respectively determines that a PEI occasion 1 is a PEI occasion associated with PO0/1/2/3, so that PEI-DCI transmitted on the PEI occasion may include four PEI fields, being respectively PEI indication messages of PO0/1/2/3. A terminal monitoring a certain PO needs to determine, in received PEI-DCI, an index of a PEI information field of the related PO.

In an optional embodiment, the terminal determines the index of the PEI field according to the distance between a PF of a PO monitored by the terminal and a PEI occasion, a minimum offset, and a paging parameter. That is, the terminal places, in a leading position according to the position of a PO indicated by a PEI, PEI indication information associated with the first PO satisfying minimum offset requirements, and then the PEI indication information is sequentially followed by PEI indication information associated with each PO of which the offset is capable of satisfying the minimum offset.

For example, the index i of the PEI field may be determined by the following formula:

i=floor[(S−K)/(T/N)]*Ns+i_s

where S is the number of radio frames between the PF in which the PO monitored by the terminal is located and the PEI occasion. K is configured by the network, is the minimum offset value between the PF and the PEI occasion, and is an integral number of radio frames. T is determined by the terminal, and is the period of a DRX cycle. N is the number of paging frames in the DRX cycle. Ns is the number of POs in one paging frame. i_s is determined by the terminal, and is the index of the PO in the PF. floor is a rounding down operation.

Optionally, the index i of the PEI field may be determined by the following formula

i=floor[(S−K)/(Nₛₗₒₜ^{frame,μ}*T/N)]*Ns+i_s

where Nₛₗₒₜ^{frame,μ} is determined according to a subcarrier parameter μ of the BWP, and is the number of slots in one radio frame. S is the number of slots between the PF in which the PO monitored by the terminal is located and the PEI occasion. K is configured by the network, is the minimum offset value between the PF in which the PO is located and the PEI, and is an integral number of slots.

Optionally, when the unit of S is not consistent with the unit of K, for example, the unit of S is a radio frame but the unit of K is a slot, the terminal may perform conversion via the relationship in bandwidth between a radio frame and a slot, and use a suitable method to determine the index of the PEI field.

The distance or offset between a PF and a PEI occasion may be measured by using different methods, and the terminal can determine the unique PEI information index by all of these methods.

Optionally, when one PEI occasion consists of one PEI-PDCCH monitoring occasion, the distance between a PF and a PEI occasion is the number of slots between the first slot of the PF frame and the last slot determined by a duration parameter of the last PEI-PDCCH monitoring occasion of one PEI occasion.

Optionally, when one PEI occasion consists of a plurality of PEI-PDCCH monitoring occasions, the distance between a PF and a PEI occasion is the number of slots between the first slot of the PF frame and the slot of the last PEI-PDCCH monitoring occasion of the PEI occasion.

Optionally, the distance between a PF and a PEI occasion is the number of radio frames between the PF and a radio frame in which the last slot of the PEI-PDCCH monitoring occasion of the PEI occasion is located.

Optionally, the distance between a PF and a PEI occasion is the number of radio frames between the PF and a radio frame of the PEI occasion. The radio frame of the PEI occasion is a radio frame including one or more PEI occasions or starts of PEI occasions.

In particular, from the angle of a certain terminal, when the terminal determines an index of PEI information according to the method described above, the terminal may not need to be concerned with whether the PEI occasion further simultaneously corresponds to other terminals, that is, may not need to be concerned with the number of PEI fields in PEI-DCI. The terminal can acquire related PEI indication information by determining the PEI field index related thereto. Optionally, the terminal may perform blind monitoring according to a default length when demodulating PEI-DCI. For example, the size of the PEI-DCI is always aligned with the size of DCI format 10 via a padding method. The terminal may solve the PEI-DCI according to the DCI size. In this case, the terminal only needs to acquire the index of the PEI information associated with the PO monitored by the terminal to acquire the PEI information. Optionally, the terminal may also acquire the capacity of a PEI occasion according to a related configuration, thereby acquiring the number of instances of PEI information in DCI. The terminal may determine the size of the PEI-DCI according to the number of instances of PEI information.

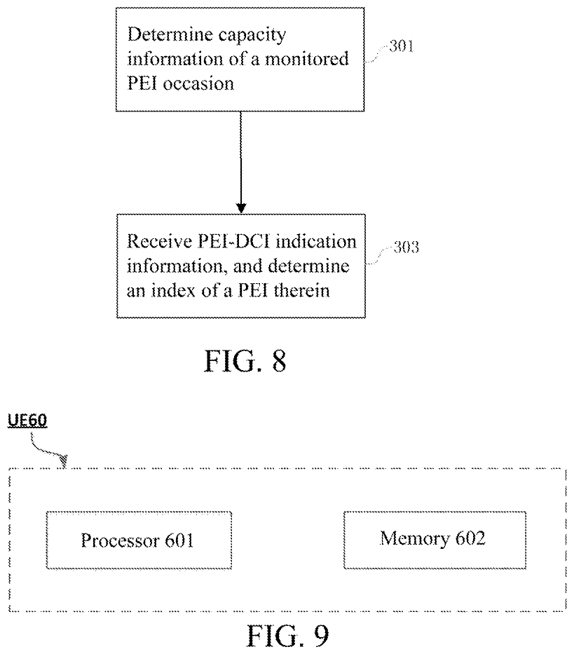

FIG. 8 shows a flowchart of a method performed by user equipment according to another embodiment of the present invention.

As shown in FIG. 8, in step 301, a terminal acquires capacity information of a PEI occasion that needs to be monitored.

Then, in step 303, the terminal determines, according to the capacity information, an index of a PEI message in DCI detected on the PEI occasion.

To reduce resource overhead in the network or avoid a conflict in PDCCH monitoring or the like, the network may configure one PEI occasion to correspond to one or more POs. That is, the terminal that monitors these POs may detect associated PEI-DCI on a related resource of one PEI occasion. This PEI-DCI may use one field to collectively indicate PEI indication information of these POs, or use a number of different fields to respectively indicate PEI indication information of these POs. The terminal may be configured according to higher layer signaling to acquire the number of POs associated with one PEI occasion, which may be referred to as the capacity of the PEI occasion and is herein denoted as D.

The terminal is configured via RRC signaling to acquire a capacity value of one PEI occasion. Optionally, the terminal acquires the capacity of one PEI occasion via period information of the PEI occasion. For example, the network configures the period of the PEI occasion to be R radio frames. The terminal may obtain the minimum spacing between two PFs according to a paging configuration parameter in the network, the minimum spacing being T/N radio frames, so that the terminal may determine that the capacity D of one PEI occasion=R/(T/N)*Ns.

Optionally, the terminal acquires the capacity of each PEI occasion according to the total capacity of PEI occasions in one DRX cycle. For example, the network configures K PEI occasions to be present in one DRX cycle. For example, K=T/8 or K=T/16 or the like, T being a paging DRX cycle determined by the terminal. The terminal may determine that N*Ns POs are present in one DRX cycle, so that the terminal may determine that the capacity of each PEI occasion is D=N*Ns/K.

Optionally, the terminal acquires the capacity of each PEI occasion according to the number of PEI frames in one DRX cycle. For example, the network configures L PEI frames to be present in one DRX cycle, and each PEI frame has M PEI occasions. For example, L=T/8 or L=T/16 or the like. The terminal may determine that N PFs are present in one DRX cycle, so that the terminal may determine that the capacity of each PEI occasion is D=N*Ns/(L*M).

In an optional embodiment, the terminal determines an index of a PEI field according to the capacity of the PEI occasion, a terminal identifier, and paging parameters.

When the capacity of the PEI occasion can divide the number of POs in a DRX cycle evenly, a PO index indicated in each PEI occasion may be considered to be cyclically repeated.

In this case, the terminal may acquire, according to a UE ID, an index i of a PEI indication message related to a monitored PO in PEI-DCI:

i=((UE_ID mod N)*Ns+i_s)mod D

where UE_ID is the same as UE_ID used by the terminal when acquiring a paging PF. Ns is configured by the network, and is the number of POs associated with a PF. i_s is the index of the PO monitored by the terminal in POs associated with the PF. N is configured by the network, and is the number of paging frames in one paging cycle.

Optionally, the terminal further determines, according to an offset value of a PEI index, the index i of the PEI indication message in the PEI-DCI:

i=((UE_ID mod N)*Ns+i_s+0)mod D

where O may be configured by a higher layer, and defines an index of a PEI indication message of a first PO in a DRX cycle in DCI. In this case, an appropriate offset value is configured, so that an index relationship indicated by a PEI occasion can remain aligned with a boundary of the DRX cycle. When the higher layer does not configure O, the terminal may use a default value of O.

In further consideration, when a network-related configuration value can ensure that the value of N*Ns is always an integral multiple of D, the above method of determining an index in PEI-DCI may be further simplified:

i=(UE_ID*Ns+i_s)mod D or

i=(UE_ID*Ns+i_s+O)mod D.

In an optional embodiment, the terminal may further determine an index of a PEI field according to the capacity of the PEI occasion, the relationship between the capacity of the PEI occasion and Ns, a terminal identifier, and a paging parameter.

Optionally, when the capacity D of the PEI occasion is less than or equal to Ns, the terminal determines that the number of POs associated with one PEI occasion is less than or equal to the number of associated POs in one PF. The terminal according to determining the index i of the PEI indication message related to the monitored PO in the PEI-DCI:

i=i_s mod D

where i_s is the index of the PO monitored by the terminal in POs associated with the PF.

Optionally, when the capacity D of the PEI is greater than Ns, the terminal determines that the number of POs associated with one PEI occasion is greater than the number of associated POs in one PF. The terminal may acquire, according to a user identifier, a parameter UE_ID for determining a paging occasion. The terminal may acquire, according to a user identifier, a parameter UE_ID for determining a paging occasion. For example, UE_ID=5G-S-TMSI mod 1024. When the terminal does not acquire the user identifier, UE_ID=0 may be used. The terminal determines the index i of the PEI indication information related to the monitored PO in the PEI-DCI:

i=(UE_ID mod N)mod(D/Ns)*Ns+i_s.

Optionally, when D is configured to cause D/Ns to divide N evenly, that is, when the number of PFs in one DRX cycle can be divided evenly by the number of PFs associated with one PEI occasion, the terminal may also determine the index i of the PEI indication message related to the monitored PO in the PEI-DCI:

i=(UE_ID mod(D/Ns))*Ns+i_s.

Optionally, the terminal further determines, according to an offset value of a PEI index, the index i of the PEI indication message in the PEI-DCI:

i=((UE_ID+O)mod N)*Ns+i_s

where O may be configured by a higher layer, and defines an index of a PEI indication message of a first PO in a DRX cycle in DCI. In this case, an appropriate offset value is configured, so that an index relationship indicated by a PEI occasion can remain aligned with a boundary of the DRX cycle.

During multi-beam transmission, the UE assumes that the same paging activation information is the same on all transmitted beams. Optionally, when DCI includes TRS validity indication information, the terminal does not assume that TRS validity indication information is the same on different beams.

Hereinafter, FIG. 9 is used to illustrate user equipment that can perform the method performed by user equipment described in detail above in the present invention as a variant embodiment.

FIG. 9 shows a block diagram of user equipment (UE) according to the present invention.

As shown in FIG. 9, the user equipment (UE) 60 includes a processor 601 and a memory 602. The processor 601 may include, for example, a microprocessor, a microcontroller, an embedded processor, and the like. The memory 602 may include, for example, a volatile memory (such as a random access memory (RAM)), a hard disk drive (HDD), a non-volatile memory (such as a flash memory), or other memories. etc. The memory 602 has program instructions stored thereon. The instructions, when run by the processor 601, can implement the above method performed by user equipment as described in detail in the present invention.

The method and related equipment according to the present invention have been described above in combination with preferred embodiments. It should be understood by those skilled in the art that the method shown above is only exemplary, and the above embodiments can be combined with one another as long as no contradiction arises. The method of the present invention is not limited to the steps or sequences illustrated above. The network node and user equipment illustrated above may include more modules. For example, the network node and user equipment may further include modules that can be developed or will be developed in the future to be applied to a base station, an MME, or UE, and the like. Various identifiers shown above are only exemplary, and are not meant for limiting the present invention. The present invention is not limited to specific information elements serving as examples of these identifiers. A person skilled in the art could make various alterations and modifications according to the teachings of the illustrated embodiments.

It should be understood that the above-described embodiments of the present invention may be implemented by software, hardware, or a combination of software and hardware. For example, various components of the base station and user equipment in the above embodiments can be implemented by multiple devices, and these devices include, but are not limited to: an analog circuit device, a digital circuit device, a digital signal processing (DSP) circuit, a programmable processor, an application-specific integrated circuit (ASIC), a field-programmable gate array (FPGA), a complex programmable logic device (CPLD), and the like.

In the present application, the “base station” may refer to a mobile communication data and control exchange center having large transmission power and a wide coverage area, including functions such as resource allocation and scheduling and data reception and transmission. “User equipment” may refer to a user mobile terminal, for example, including terminal devices that can communicate with a base station or a micro base station wirelessly, such as a mobile phone, a laptop computer, and the like.

In addition, the embodiments of the present invention disclosed herein may be implemented on a computer program product. More specifically, the computer program product is a product provided with a computer-readable medium having computer program logic encoded thereon. When executed on a computing device, the computer program logic provides related operations to implement the above technical solutions of the present invention. When executed on at least one processor of a computing system, the computer program logic causes the processor to perform the operations (the method) described in the embodiments of the present invention. Such a setting of the present invention is typically provided as software, codes, and/or other data structures provided or encoded on computer-readable media such as, e.g., an optical medium (e.g., a CD-ROM), a flexible disk, or a hard disk, or other media such as firmware or micro codes on one or more ROM or RAM or PROM chips, or a downloadable software image, a shared database, and the like in one or more modules. Software or firmware or such configuration may be installed on a computing device such that one or more processors in the computing device perform the technical solutions described in the embodiments of the present invention.

In addition, each functional module or each feature of the base station device and the terminal device used in each of the above embodiments may be implemented or executed by a circuit, which is usually one or more integrated circuits. Circuits designed to execute various functions described in this description may include general-purpose processors, digital signal processors (DSPs), application-specific integrated circuits (ASICs) or general-purpose integrated circuits, field-programmable gate arrays (FPGAs) or other programmable logic devices, discrete gates or transistor logic, or discrete hardware components, or any combination of the above. The general purpose processor may be a microprocessor, or the processor may be an existing processor, a controller, a microcontroller, or a state machine. The aforementioned general purpose processor or each circuit may be configured by a digital circuit or may be configured by a logic circuit. Furthermore, when advanced technology capable of replacing current integrated circuits emerges due to advances in semiconductor technology, the present invention can also use integrated circuits obtained using this advanced technology.

While the present invention has been illustrated in combination with the preferred embodiments of the present invention, it will be understood by those skilled in the art that various modifications, substitutions, and alterations may be made to the present invention without departing from the spirit and scope of the present invention. Therefore, the present invention should not be limited by the above-described embodiments, but should be defined by the appended claims and their equivalents.

1-5. (canceled)

6. A method of paging early indication (PEI) detection in PEI downlink control information (DCI) performed by a user equipment (UE), the method comprising:
in RRC_IDLE or RRC_INACTIVE states, receiving the PEI DCI;
determining an index i by calculating i=((UE_ID mod N)*Ns+i_s)mod D, the index i being an index used to determine, from the PEI DCI, a PEI indication associated with a paging occasion (PO), the PEI indication is one of a plurality of PEI indications included in the PEI DCI, the PO is one of a plurality of POs associated with one PEI occasion, each of the plurality of POs is mapped to corresponding one or more of the plurality of PEI indications;
determining the PEI indication according to the index i; and
determining whether to monitor the PO according to the PEI indication, wherein
the UE_ID is a parameter acquired according to a Temporary Mobile Subscriber Identity (TMSI) of the UE,
the Ns is a number of POs associated with a paging frame (PF),
the N is a number of total PFs in one paging cycle,
the i_s is the index of the PO, and
the D is a number of the plurality of POs associated with the one PEI occasion.

7. A User Equipment (UE) comprising:
a processor; and
a memory storing instructions,
wherein the processor is configured by the instructions to:
in RRC_IDLE or RRC_INACTIVE states, receive paging early indication (PEI) downlink control information (DCI);
determine an index i by calculating i=((UE_ID mod N)*Ns+i_s) mod D, the index i being an index used to determine, from the PEI DCI, a PEI indication associated with a paging occasion (PO), the PEI indication is one of a plurality of PEI indications included in the PEI DCI, the PO is one of a plurality of POs associated with one PEI occasion, each of the plurality of POs is mapped to corresponding one or more of the plurality of PEI indications;
determine the PEI indication according to the index i; and
determine whether to monitor the PO according to the PEI indication, wherein
the UE_ID is a parameter acquired according to a Temporary Mobile Subscriber Identity (TMSI) of the UE,
the Ns is a number of POs associated with a paging frame (PF),
the N is a number of total PFs in one paging cycle,
the i_s is the index of the PO, and
the D is a number of the plurality of POs associated with the one PEI occasion.

8. The UE according to claim 7, wherein
the PEI indication is a 1-bit indication which is a part of multiple bits associated with the PO,
the multiple bits are multiple PEI indications associated with respective UE groups, and
the PEI indication is associated with a UE group in which the UE is located.

9. A base station comprising:
a processor; and
a memory storing instructions,
wherein the processor is configured by the instructions to:
configure paging early indication (PEI) downlink control information (DCI); and
transmit, to a user equipment (UE) in RRC_IDLE or RRC_INACTIVE states, the PEI DCI, wherein
the PEI DCI is information causes the UE to:
determine an index i by calculating i=((UE_ID mod N)*Ns+i_s)mod D, the index i being an index used to determine, from the PEI DCI, a PEI indication associated with a paging occasion (PO), the PEI indication is one of a plurality of PEI indications included in the PEI DCI, the PO is one of a plurality of POs associated with one PEI occasion, each of the plurality of POs is mapped to corresponding one or more of the plurality of PEI indications;
determine the PEI indication according to the index i; and
determine whether to monitor the PO according to the PEI indication, wherein
the UE_ID is a parameter acquired according to a Temporary Mobile Subscriber Identity (TMSI) of the UE,
the Ns is a number of POs associated with a paging frame (PF),
the N is a number of total PFs in one paging cycle,
the i_s is the index of the PO, and
the D is a number of the plurality of POs associated with the one PEI occasion.

10. The base station according to claim 9, wherein
the PEI indication is a 1-bit indication which is a part of multiple bits associated with the PO,
the multiple bits are multiple PEI indications associated with respective UE groups, and
the PEI indication is associated with a UE group in which the UE is located.
